(19) United States
(12) Patent Application Publication
(10) Pub. No.: US 2010/0186904 A1
(43) Pub. Date: Jul. 29, 2010

(54) AESTHETIC AND SANITARY VERTICAL BLIND COVERS

(76) Inventor: Shannon Merritt, Manchester, NH (US)

Correspondence Address: MESMER & DELEAULT, PLLC, 1 NEW HAMPSHIRE AVE., SUITE 125, PORTSMOUTH, NH, 03801, US

(21) Appl. No.: 12/693,932

(22) Filed: Jan. 26, 2010

Related U.S. Application Data
(60) Provisional application No. 61/147,226, filed on Jan. 26, 2009.

(51) Int. Cl. E06B 9/24; D05B 1/00

(52) U.S. Cl. 160/89; 29/428; 112/475.08

(57) ABSTRACT

A cover assembly for vertical blinds comprising a front cover having an aesthetically pleasing design having a front cover top, bottom, and two sides; a back cover having a back cover top, bottom, and two sides, the back cover secured to the front cover at their respective two sides and bottom; and a securing means for closing the front cover top and back cover top that does not close a middle section of the top to permit the stem to pass through, the securing means taken from the group consisting of snaps, buttons, hook and loop fasteners, elastic ribbon, and a drawstring.

### BACKGROUND

1. Field of the Invention

The invention relates to enhancements for vertical blinds.

2. Description of the Related Art

Vertical blinds are popular devices for covering patio doors and windows. They are typically made of an elongated panel that has stem at its top for connecting to a twisting and/or side drawing mechanism. Vertical blinds get dirty and must be cleaned periodically. They collect dust, smoke, pollen, grease, pet hair, cobwebs, and the like. In the home, it is unsightly. In hospitals and restaurants, it is particularly unhealthy.

It is possible to clean vertical blinds while they are hung, but it is difficult to clean them effectively. To clean them effectively, one must detach them at the stem, lay them on the ground, and wash them by hand. It is a cumbersome chore, and requires a great deal of effort. Because it is so difficult, it is unlikely that blinds are cleaned often enough.

When closed, vertical blinds always present a uniformly bland appearance. What is needed, therefore, is a device that makes vertical blinds aesthetically pleasing and easy to clean.

### SUMMARY

The invention satisfies the need for a device that makes vertical blinds aesthetically pleasing and easy to clean. The invention is a cover assembly for vertical blinds comprising a front cover having an aesthetically pleasing design having a front cover top, bottom, and two sides; a back cover having a back cover top, bottom, and two sides, the back cover secured to the front cover at their respective two sides and bottom; and a securing means for closing the front cover top and back cover top that does not close a middle section of the top to permit the stem to pass through, the securing means taken from the group consisting of snaps, buttons, hook and loop fasteners, elastic ribbon, and a drawstring. These and other features, aspects, and advantages of the present invention will become better understood with regard to the following drawings, description, and claims.

### DRAWINGS

FIG. 1 shows a front or back panel according to the present invention that uses an elastic securing means as one embodiment.

FIG. 2 is an orthogonal view of a front and back panel assembled covering a vertical blind panel.

FIG. 3 shows another embodiment that uses snaps as a securing means.

FIG. 4 shows another embodiment that uses hook and loop fasteners as a securing means.

FIG. 5 shows another embodiment that uses buttons as a securing means.

FIG. 6 shows another embodiment that uses a drawstring as a securing means.

FIG. 7 is a process flow chart of a method of making the present invention.

### DESCRIPTION

The invention is a cover assembly for vertical blinds comprising a front cover having an aesthetically pleasing design having a front cover top, bottom, and two sides; a back cover having a back cover top, bottom, and two sides, the back cover secured to the front cover at their respective two sides and bottom; and a securing means for closing the front cover top and back cover top that does not close a middle section of the top to permit the stem to pass through, the securing means taken from the group consisting of snaps, buttons, hook and loop fasteners, elastic ribbon, and a drawstring.

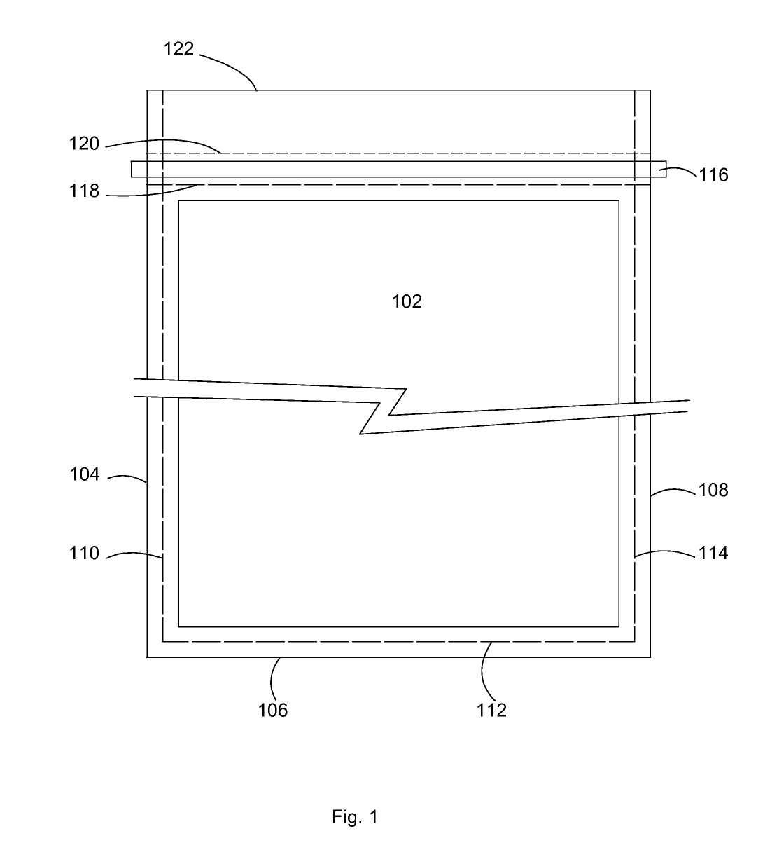

Turning to FIG. 1, a standard vertical blind panel 102 is the object to be covered. The panel 102 is typically about 3.75 inches wide by about 82.5 inches long. Another panel can be provided for covering the top vertical blind assembly, which would be about 90 inches long.

A back cover 101 is provided that is wider than the panel 102 by about 0.125 inches per side, or about 0.25 inches wider overall. This 0.125 inch dimension has been shown to work the best aesthetically and in its manufacturing and installation. The back cover 101 is therefore about four inches wide and has a back cover top 122, back cover sides 104 and 108, and a back cover bottom 106. A securing means is provided, which in this figure is a length of elastic ribbon 116 about six inches long that is positioned below a fold line 120. A front panel, not shown, is provided having about the same dimensions. The front and back panel covers 101 are then secured together along a first side stitch 110, bottom stitch 112, and second side stitch 114. Then the securing means 116 is substantially enclosed by making a circle stitch 118 around both front and back panel covers, thereby leaving the top open. The front and back panel cover assembly is then turned inside out and can be slipped over a panel 102 like a pillowcase. The elastic ribbon 116 can be tied around a stem to keep it in place. The vertical blind cover assembly is individually manufactured, and not cut from a roll of material.

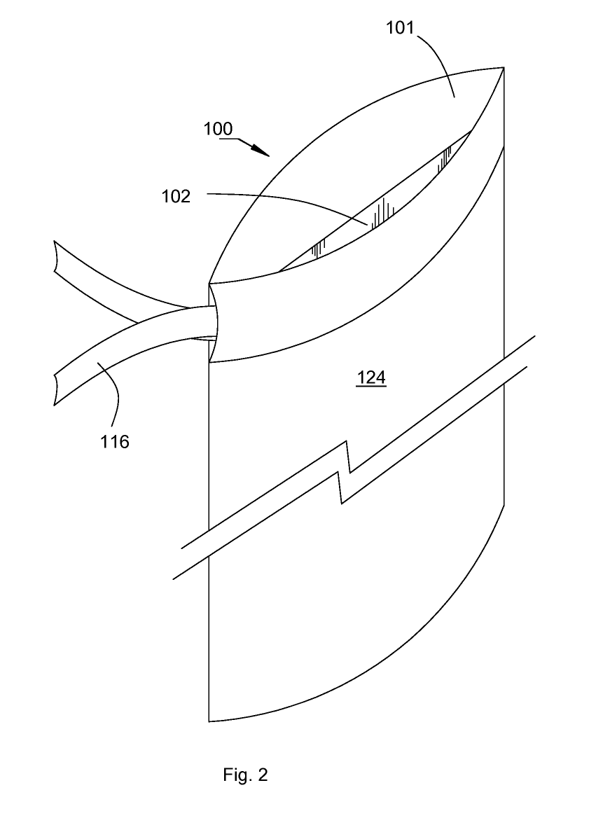

FIG. 2 shows the embodiment of FIG. 1 as a completed assembly 100 in an orthogonal view. The panel 102 is disposed within the back panel cover 101 and front panel 124.

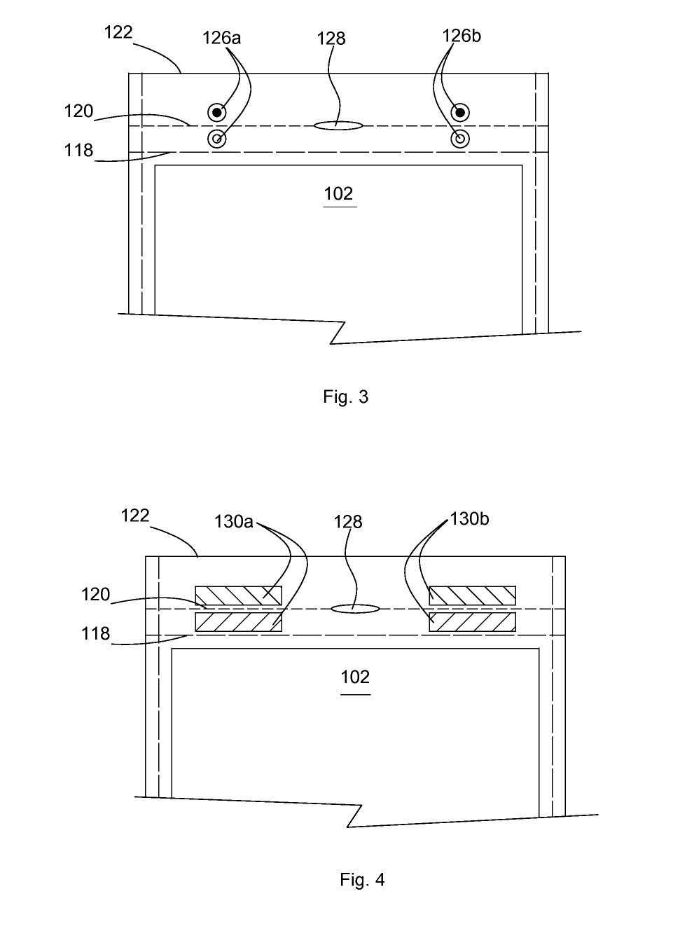

FIG. 3 shows another embodiment of the present invention that uses two sets of snaps 126a, 126b that are secured to one of the panels. The snaps are another securing means. A slot 128 is made in the middle section of a panel along the fold line 120 to allow the panel stem to pass through when assembled.

FIG. 4 shows yet another embodiment of the present invention. In this embodiment, VELCRO hook and loop fasteners 130a and 130b are provided as the securing means along either side of the fold line 120.

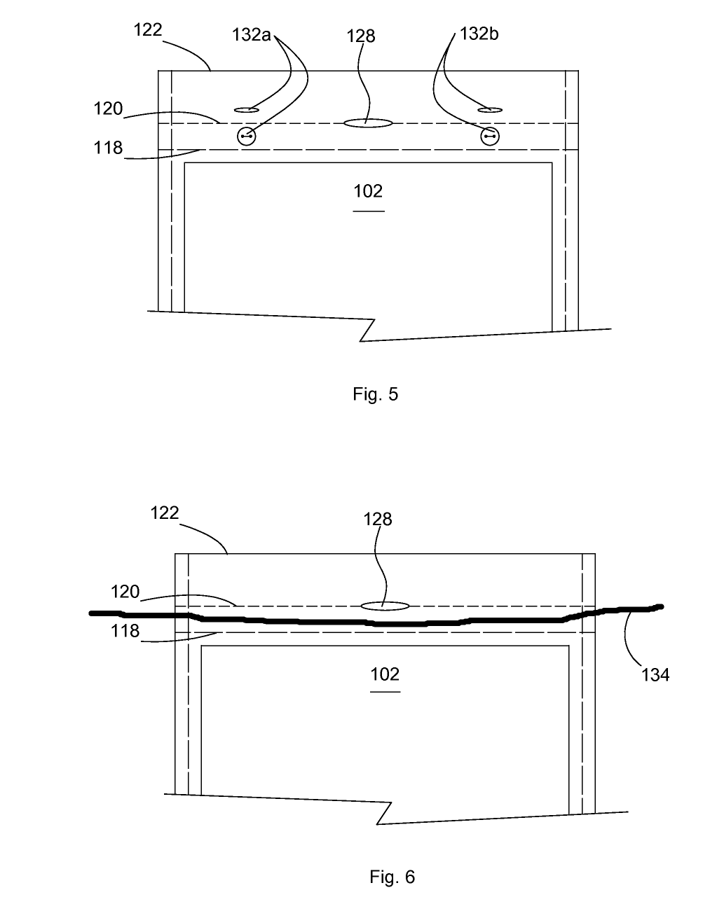

FIG. 5 shows still another embodiment of the present invention. In this embodiment, a set of buttons and buttonholes 132a, 132b are the securing means.

FIG. 6 displays an embodiment that uses a drawstring 134 as the securing means. Other securing means could also be employed.

The invention is not limited to the specific sizes mentioned in this specification. However, having pocket about ⅛ inch wider than the panel 102 on each side is important for aesthetics and ease of assembly.

The front cover 124 and back cover 101 can be made of many different fabrics, including but not limited to cotton cloth, polyester, velvet, linen, and silk. It is a simple matter to untie the securing means and remove the covers for washing or dry cleaning. Frequent washing keeps them looking clean and removes smoke, dirt, odors, and germs. They are therefore more sanitary than bare panels.

One can be very creative when selecting the colors and patterns that will show on the outside of the assembly 100. The back cover 101 is seen outside a window. It might be white to reflect light and keep the room cool. It might be another solid color. However, one could also apply a pattern or image to a series of adjacent back covers that matches the outside of the building so that the window is nearly invisible. They could be provided as a set. One could also create sequence of adjacent covers that, when closed and positioned side-by-side form an image. Each cover could have one slice of the image that becomes visible as a whole image when installed in sequence adjacent to each other. The back panel could show a false view of the inside of the building, for example, either as a photograph or painting.

The front panel covers 124 could present a design that is the same on all of the panels, such as flowers, holiday motifs, seasonal motifs, and product logos. The front panels when assembled adjacent to each other and the blinds are closed could also be different from one another and form an image. Like with the back covers, each cover could have one slice of the image disposed on the cover that becomes visible when installed in the correct sequence adjacent to each other. The image could be outdoors scenery, a painting, or photograph, for example. There may be themes for different rooms and for special occasions. Sets of designs could be provided that are suitable for residences, commercial buildings, and health care facilities. They could also be provided as a set. These examples are not meant to be limiting. In this way, the blind covers 100 are not only sanitary, but also aesthetically pleasing.

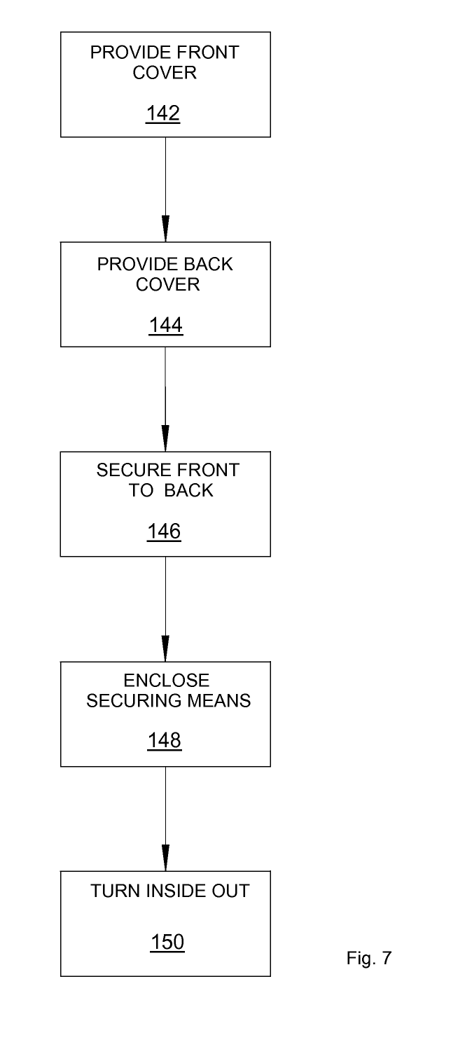

FIG. 7 is a process flow chart of a method of making the present invention. It closely follows the description of FIG. 1. A method of making aesthetic and sanitary vertical blind cover assemblies comprises the steps of providing a back cover that is about 0.125 inches wider than a vertical blind cover 142; providing a front cover that has about the same dimensions as the back cover 144; securing the front cover and back cover together along a first side stitch; a bottom, stitch, and a second side stitch 146; enclosing a securing means by making a circle stitch around both front and back covers, thereby leaving a top open 148; and turning the assembly inside out for installation onto a panel 150.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

I claim:

1. An aesthetic and sanitary vertical blind cover assembly for vertical blind panels having at least one elongated panel supported at the top by a stem, the cover comprising:
a front cover having an aesthetically pleasing design having a front cover top, bottom, and two sides;
a back cover having a back cover top, bottom, and two sides, the back cover secured to the front cover at their respective two sides and bottom; and
a securing means for closing the front cover top and back cover top that does not close a middle section of the top for permitting a panel stem to pass through.

2. The vertical blind cover assembly of claim 1, wherein the front cover and the back cover are wider than a vertical blind panel by about 0.25 inches.

3. The vertical blind cover assembly of claim 1, wherein the front cover and the back cover are about four inches wide.

4. The vertical blind cover assembly of claim 1, the securing means taken from the group consisting of snaps, buttons, hook and loop fasteners, elastic ribbon, and a drawstring.

5. The vertical blind cover assembly of claim 1, wherein the front cover is made of one taken from the group consisting of cotton cloth, polyester, velvet, linen, and silk.

6. The vertical blind cover assembly of claim 1, wherein the back cover is made of one taken from the group consisting of cotton cloth, polyester, velvet, linen, and silk.

7. A set of vertical blind covers for vertical blind panels having at least one elongated panel supported at the top by a stem comprising a plurality of vertical blind cover assemblies, each cover comprising:
a front cover having a front cover top, bottom, and two sides;
a back cover having a back cover top, bottom, and two sides, the back cover secured to the front cover at their respective two sides and bottom; and
a securing means for closing the front cover top and back cover top that does not close a middle section of the top for permitting a panel stem to pass through; and
a slice of an image disposed on a front or back cover, the image becoming visible when the set of covers are installed in sequence adjacent to each other.

8. The set of vertical blind covers of claim 7, wherein the image of an outside wall of a building is disposed on the back covers, thereby making a window nearly invisible from the outside.

9. The set of vertical blind covers of claim 7, wherein the image of outdoor scenery is disposed on the front covers, thereby making the blinds appear open when they are closed.

10. A method of making aesthetic and sanitary vertical blind cover assemblies comprising the steps of:
providing a back cover that is about 0.125 inches wider than a vertical blind cover;
providing a front cover that has about the same dimensions as the back cover;
securing the front cover and back cover together along a first side stitch, a bottom, stitch, and a second side stitch;
enclosing a securing means by making a circle stitch around both front and back covers, thereby leaving a top open; and
turning the assembly inside out for installation onto a panel.
